(19) United States
(12) Patent Application Publication
(10) Pub. No.: US 2002/0002491 A1
(43) Pub. Date: Jan. 3, 2002

(54) Method of advertising over networks

(76) Inventor: Timothy Rex Whitfield, Frenchs Forest (AU)

Correspondence Address: YOUNG & THOMPSON, 745 SOUTH 23RD STREET 2ND FLOOR, ARLINGTON, VA, 22202

(21) Appl. No.: 09/835,411

(22) Filed: Apr. 17, 2001

(30) Foreign Application Priority Data
Apr. 17, 2000 (AU) PQ6947

(51) Int. Cl. G06F 17/60

(52) U.S. Cl. 705/14

(57) ABSTRACT

An advertising system that is applicable to the Internet is disclosed. A number of publisher sites which provide content and have advertising space all have a link to an advertisement host server which can identify end users that send a request to a publisher site by using application variables, so cookies are not required. Application server pages are used to provide the required information and to prevent caching of advertisements on users' machines. Data obtained by the system is used by the advertisement host server to select an appropriate advertisement, and the advertisements are uploaded from an SQL database and provided to the user in binary format.

### FIELD OF THE INVENTION

This invention relates to the provision of advertising over networks such as the Internet, and has particular application to the provision of banner advertisements.

### BACKGROUND

Advertising on the Internet typically makes use of banners, which “float” above the content being displayed on the user's browser as the user looks at the information provided by a host server. Typically the banner and its content is fixed, so that any user looking at the content on the host server will see the same banner advertisement. When the user views a web page using his or her browser such as Netscape or Internet Explorer, the banner will typically appear at a fixed location on the screen. If the user decides to select the advertisement shown on the banner, they will typically use a pointing device such as a mouse, and place the pointer over the selected advertisement and issue a command by “clicking” the mouse to “click through” on that banner. The user's browser will return information from the website associated with that banner. Typically this will take the user to the advertiser's home page.

The are problems with such techniques, as users have a very low response rate with fixed banners, and in many cases uses completely ignore them. It is well known that repeating an advertisement too often, as happens with fixed banners, will result in the advertisement being ignored by consumers.

It is desirable to vary the banners by rotating them through a series of advertisements, making use of as much graphic information as possible, to make the banners interesting to look at to attract customers. However, existing techniques have limitations. Some banner rotation techniques require a long URL with encoded information to be passed from the client to the server. By disclosing such information to Publishers and End Users there is a risk that hacking could occur, and at the very least this would show competitors how this type of advertising service is being provided.

With some techniques a random number generator is used to generate some type of time stamp or number to add to the suffix of the image tag that is part of the advertisement banner in order to provide information for banner rotation. Use of such numbers creates complications, as they have inherent problems with their randomness, size and ability to conform to World Wide Web Consortium (W3C) standards in Uniform Resource Locator (URL) parsing.

Other techniques require “cookies” to be activated on the client machines before rotation of the banners can occur. Cookies are relatively small pieces of identification information that a host site passes to a user's machine. The information can then be retrieved by the host site. when the user again “visits” the site and used by the host to obtain and identify information about the user. Cookies have the disadvantage that the information is stored on the hard disk of the user's machine. Therefore, it takes time to request, read, and receive the information. Delay in the online environment is undesirable from the viewpoint of the user and the advertiser. The user does not want to wait very long fox the publisher's page to load, and may simply go to another site or click through to other content on the publisher's site, if the wait is too long. The advertiser obviously wants to have the user view the advertisement, so an advertisement that does not appear quickly is a disadvantage.

Because of the difficulties in providing rotating banners, most advertisers rely on static JPG files on a server. They are limited then to a fixed banner associated with their website.

### OBJECT

It is an object of this invention to provide an improved method of advertising over networks such as the Internet, and in particular one which does not require the use of cookies on a user machine, or one which will at least provide the public with a useful choice.

### SUMMARY OF THE INVENTION

In one aspect, but not the only aspect, the invention provides a method of advertising on a network having a user node including a browser program coupled to the network, a publisher node, and an advertiser host node having advertising content. The method includes the steps of

sending a request from the user node to the publisher node,

returning an advertisement link from the publisher node to the user node, the link being a link to the advertiser host node,

the user node using the link to send a request to the advertiser host node for an advertisement, and

the advertiser host selecting an advertisement and sending the advertisement to the user node to be displayed by the browser program.

In another aspect the invention provides a network having

a user node including a browser program coupled to the network, the user node being capable of making requests for information on the network.

An advertiser host node is also provided having advertising content, and means to select an advertisement and return the selected advertisement to the user node.

The network also includes a publisher node having information including advertising space for display of advertising content, and a link to the advertiser host node.

When a request from the user node to the publisher node ocurs, the publisher node returns the link to the advertiser host node to allow the advertiser host node to select an advertisement and return the selected advertisement to the user node.

A plurality of publisher nodes may be provided, each publisher node returning a link to the advertiser host node for retrieving advertising information from the advertiser host node.

One or more application variables may be passed from the user node to the advertiser host node when the user node sends the request to the advertiser host node.

The advertising node may use one or more variables to provide identifying information regarding the end user node.

The identifying information is preferably used to select an appropriate advertisement.

The advertiser host node preferably makes a data base request for an advertisement,

The graphic content of the advertisement is preferably provided in binary data format.

The advertisement is preferably sent to the user node with a command that the advertisement not be cached by the user node.

The browser may be used to select the advertisement, and send a request to an advertising node.

In this specification we use the following terms;

Publisher or Publisher's Server to refer to the content provider (or its server) eg. Yahoo, Excite, or any ISP providing a web site that can be accessed by end users. The Publisher's sever will typically have a well known URL.

Client - The company that pays for the advertisement to be published on the Publisher's server.

Host or Host Server - The business that stores and delivers the advertisements to the end user via the Publisher's server.

Creative files - The advertisements, typically graphics files or a mixture of graphics and text.

Active Server Page (or ASP) - an HTML page that includes one or more scripts that may be processed by a server before the page is sent to a user.

These and other aspects of this invention, which should be considered in all its novel aspects, will become apparent from the following description, which is given by way of example only with reference to the accompanying drawings.

### BRIEF DRAWING DESCRIPTION

FIG. 1 shows a diagram explaining the transfer of information between a Publisher's site and the host server.

### DESCRIPTION OF PREFERRED EMBODIMENT

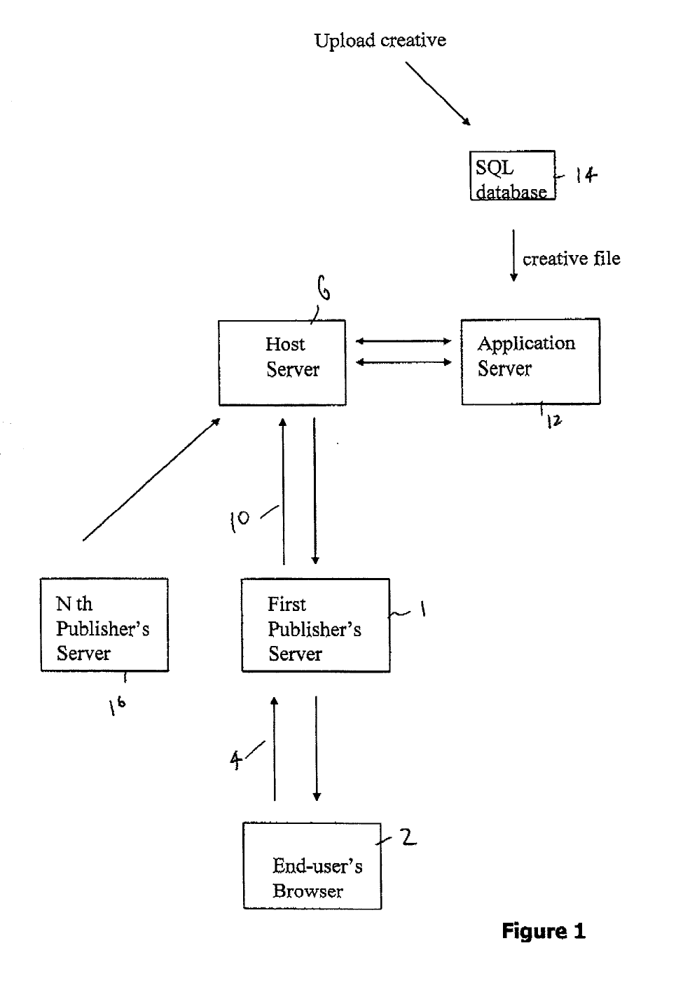

In FIG. 1, a first Publisher's server 1 is provided at an appropriate node on a network such as the Internet. The server has files that provide content to be viewed by an end user 2. The end user will have a networked machine, such as a personal computer, for example, which accesses the network through an appropriate service provider provided at another node on the Internet. The user's machine will have software for reading files obtained over the Internet, referred to herein as a “browser”. The end user's browser will receive the information in the form of Hypertext Markup Language (HTML) pages from the Publisher's server. This will typically include advertisements in the form of banners or boxes which “float” above the content. However, the advertisements could be provided at any desired location relative to the remaining content.

In practice, the end user will select a link, or enter a URL that points to the network node on which the Publisher's server is located. This will result in an HTML request 4 being generated by the user's browser and sent to the Publisher's server. The Publishers'servers have a source link for the image or creative files and the Anchor (i.e. the target of the hypertext link) for the relevant HTML files that will form the advertisement. These files are provided on the Host server 6.

Therefore, the first Publisher's server will respond to the request from the end user by sending the user an HTML page 8 containing information, such as general content on the first Publisher's site. As described above, the first Publisher's server has a link to the host server. This link forces a connection 10 between the end user and the Host server, When the connection between the host server and the end user has been established, several server variables are transmitted from the end user's machine (or server) to the, Host server. These variables may be any desired variables that allow some form of identification of the end user, or allow some further information to be ascertained about the end user. Therefore, the variables may be any which are capable of being passed in, or as a result of, HTML requests. For example, the variables may be ones which enable one or more software applications present on the end user's machine to be ascertained, such as WINDOWS 98, if the user happens to have this application installed.

The selected variables that are passed from the end user to the Host server are stored on a database. This provides the advantage that the data may be used for subsequent statistical analysis. For example, an analysis may be socio-economic in nature so that advertisements may be demographically focussed and thus achieve better results than advertisements that are very broad.

The connection between the end user and the Host server having been made, and the appropriate variables passed, the end user's browser requests a graphic or Creative file that delivers the advertisement to accompany the content provided by the first Publisher's server. Usually, the Creative will constitute one advertisement that is part of an overall advertising campaign. Thus a campaign may comprise a series of banner advertisements.

A decision is made by the Host server as to which creative file to pass to the end user. As outlined above, the Host server has access to a database of information identifying the end user. This database may be provided on an application server 12, and is queried by the Host server to ascertain whether the end user has viewed any advertisements from the campaign that the Client currently wishes to pursue If the end user has not viewed any advertisements from the campaign, then the first advertisement in the series comprising the campaign is selected. If the database reveals that the end user has already viewed an advertisement from the campaign, then either the next advertisement in the campaign is selected or a specific advertisement that matches the end user's demographic profile will be selected. The selection is therefore dependent on the amount of data the Host server has about the end user. For example, if the variables passed to the Host server by the end user indicate that the end user has WINDOWS 98 installed on his or her machine, then a certain advertisement may be selected based on this information. The advertisement may relate to a WINDOWS application upgrade, for example. As another example, the variables that are passed to the Host server may indicate that the end user is in China, so an advertisement that is written in Chinese characters may be selected.

When the advertisement has been chosen the Host server selects the Creative file from a database, The database is preferably one which is capable of being queried using Structured Query Language (SQL), and the Creative file is preferably provided in the form of binary data, The Creative, in the form of binary data, is sent to the end user's browser which interprets the binary data and displays the resultant advertising graphic,

Once the Creative has been sent to the end user, the end user information database maintained by the Host server is updated with the identity of the Creative that has been delivered. In this way the database can be used in future to assist in selecting the next advertisement to be delivered to the end user, and for analysis purposes.

Should the end user now “click” on the advertisement, the end user's browser will make a request to a dynamic banner server (which may also be run by the Host server). This request announces the identity of the end user and also which Creative the end user last viewed. This information is again recorded on the end user information database, and a lookup table which cross-references the particular creative with a selected URL inside the client's website is searched to return the required URL. The Host server then redirects the end user to the specific URL as stored in the table. From this point the end user will usually be able to find out more information, or purchase the product of service to which the advertisement relates.

This technique has significant advantages. It enables each Publisher's server to link to a static URL and then receives the appropriate creative files from the SQL database.

There can be many different Publishers having links to the URL of the Host server. An Nth Publisher's server is shown to the left of FIG. 1.

We have found that the system can be implemented very effectively using Active Server Pages (ASP), which is a feature of MICROSOFT INTERNET INFORMATION SERVER (IIS). Thus, the system of the present invention is based on the idea of providing all publishers with the same static URL to link to a host server and then using ASP to distinguish between end users and to distinguish between Publisher's servers if required. This enables the Host server to export HTML files containing binary data to the end user.

We have not found any other solution that provides a simple static URL which rotates banners with cookies turned off,

Downloading our graphics from the SQL database was at least as fast as pulling them from an HTTP server. In fact, as the database is indexed, returning the images does not require any interaction with the FileSystemObject on the Host server. Therefore, even if the Host server is busy executing file object requests it can still respond with the creative very quickly. This technology is more than comparable in speed to all other current file download technologies.

Our preferred infrastructure (NT Server with IIS) is extremely scalable by daisy-chaining servers. Having thousands of simultaneous hits does not introduce any impediment to performance.

As our system is designed not to use cookies, and is based on a simple static URL, we also knew that we needed some means to capture all user data. Hence we decided upon ASP to capture the user's session variables, however we still encountered problems returning a creative to the user in an IMG SRC tag. We found it best to avoid the use of FileSystemObject as it was slower and harder to use and adopted instead the SQL Blob field technique where the creative is uploaded to a field in a SQL database as binary data and then downloaded to the clients browser with a ResponseBinaryWrite technique via the Publisher's server.

We have found that download times of images is at least as fast, and possibly even faster than existing techniques, as the database was indexed and quick to return the image, It also has the advantage of quickly changing advertisements to suit the origination and interest of a particular end-user (e.g. a Publisher's site may receive hits from countries around the world and be able to respond with advertisements specific to a particular end-user's country). The response may be targeted to the end-user's interests, which may be gauged initially from the pages that the end user views. A general profile on that end user may be built up by the host server from contact with that end user over time as the end user visits different Publisher's sites (1 to N) associated with the Host server.

The Host server can then provide information to clients on the effectiveness of their advertisements, as it is possible to provide the Client with the number of end-users who did not “click-though”, as well as the number of users who did click through the banner to the client's destination (usually the clients main web site). We have found that we are able to use ASP to give further significant advantages in connection with the system of the present invention. HTML pages are usually cached in users'machines. In this way, when a user revisits a recently visited page, the content of the page can be retrieved directly from the cache rather than having to be retrieved from the remote server on which the content was originally retrieved. Although this is useful in some circumstances, it does not promote a turnaround of advertisements. By use of ASP, the HTTP headers of a request can be set via a response object. The Urn'request can therefore be set to be expired before it reaches the user. This means that each time the user receives information from ASP that information will not be cached. The benefit of this approach to our system is that we can use the ASP code to include the expression Response Expires=0. In this way the images received by the user will not be cached, and the browser will request a fresh advertisement. using ASP to pass selected variables from the end user's browser request, we are able to simplify the delivery of advertisement delivery. Cookies or long Us or image tags that have random numbers attached as a suffix are not required.

A further aspect of the invention relates to the use of application variables to retrieve the required user information. ASP has memory space for session and application variables. Session variables are invariably stored on the user machine in the form of cookies. Application variables include information stored in memory on the web server during a session by a user. All users have access to these application variables. In general, accessing memory on a personal computer is faster than accessing a file on a disk or a record in a database. Therefore, a request to memory to access the application variables is not affected by the, mad speed of the user's hard disk nor by the system pooling that queues reads from disks.

Furthermore, in accordance with the present invention, the Host server running ASP can take advantage of the application variables by storing a complete listing of Creatives in a relatively small section of memory. Then when a Creative is requested, the server can access the Creative in a much more expedient manner from memory, without needing to access the disk.

1. a method of advertising on a network having a user node including a browser program coupled to the network, a publisher node, and an advertiser host node having advertising content, the method including the steps of
sending a request from the user node to the publisher node,
returning an advertisement link from the publisher node to the user node, the link being a link to the advertiser host node,
the user node using the link to send a request to the advertiser host node for an advertisement,
the advertiser host selecting an advertisement and sending the advertisement to the user node to be displayed by the browser program:

2. A method as claimed in claim 1 including the step of providing a plurality of publisher nodes, each publisher node returning a link to the advertiser host node for retrieving advertising information from the advertiser host node.

3. A method as claimed in claim 1 including the step of passing one or more application variables from the user node to the advertiser host node when the user node sends the request to the advertiser host node.

4. A method as claimed in claim 3 including the step of the advertising node using the one or more variables to provide identifying information regarding the end user node.

5. A method as claimed in claim 4 including the step of using the identifying information to select an appropriate advertisement.

6. A method as claimed in claim 1 including the step of the advertiser host node making a data base request for an advertisement.

7. A method as claimed in claim 1 including the step of providing the graphic content of the advertisement in binary data format.

8. A method as claimed in claim 1 wherein the advertisement is sent to the user node with a command that the advertisement not be cached by the user node.

9. A method as claimed in claim 1 including the step of the browser being used to select the advertisement, and sending a request to an advertising node.

10. A network having
a user node including a browser program coupled to the network, the user node being capable of making requests for information on the network,
an advertiser host node having advertising content, and means to select an advertisement and return the selected advertisement to the user node,
a publisher node having information including advertising space for display of advertising content, and a link to the advertiser host node
whereby a request from the user node to the publisher node results in the publisher node returning the link to the advertiser host node to allow the advertiser host node to select an advertisement and return the selected advertisement to the user node.

11. A network as claimed in claim 10 including a plurality of publisher nodes, each publisher node returning a link to the advertiser host node for retrieving advertising information from the advertiser host node.

12. A network as- claimed in claim 10 wherein the advertiser host node includes means to receive one or more application variables from the user node when the user node sends the request to the advertiser node.

13. A network as claimed in claim 12 wherein the advertising node uses the one or more variables to provide identifying information regarding the end user node.

14. A network as claimed in claim 13 wherein the identifying information is used to select an appropriate advertisement.

15. A network as claimed in claim 10 wherein the advertiser host node, makes a data base request for an advertisement.

16. A network as claimed in claim 10 wherein the graphic content of the advertisement is provided in binary data format.

17. A network as claimed in claim 10 wherein the advertisement is sent to the user node with a command that the advertisement not be cached by the user node.

18. A network as claimed in claim 10 including an advertising node to which the browser sends a request upon the advertisement returned to the user node being selected.
